(19) United States
(12) Patent Application Publication
(10) Pub. No.: US 2026/0177457 A1
(43) Pub. Date: Jun. 25, 2026

(54) DEVICE FOR PROVIDING CONTROL COMMANDS, MOTOR VEHICLE, METHOD FOR CONTROL AND DRIVING DYNAMICS TESTING

(71) Applicant: AUDI AG, Ingolstadt (DE)

(72) Inventors: Christoph FRANKE, Ingolstadt (DE); Kevin KONRADT, Ingolstadt (DE)

(73) Assignee: AUDI AG, Ingolstadt (DE)

(21) Appl. No.: 19/425,572

(22) Filed: Dec. 18, 2025

(30) Foreign Application Priority Data
Dec. 20, 2024 (DE) 10 2024 139 522.2

(51) Int. Cl. G01M 17/007; B60W 50/00; B60W 50/14

(52) U.S. Cl. CPC G01M 17/007; B60W 50/14; B60W 2050/002; B60W 2050/0043

(57) ABSTRACT

Particularly in conjunction with prototype testing of new control units, in addition to the current control unit according to an earlier variant, the control unit according to a newer control unit variant is also present in a motor vehicle (preferably motor vehicle prototypes), wherein a device decides whether the control commands from the first control unit or from the second control unit are forwarded during operation to the devices (actuators) of the motor vehicle to be controlled.

### CROSS REFERENCE TO RELATED APPLICATIONS

This application is a based upon and claims the priority benefit of German Application No. 10 2024 139 522.2 filed on Dec. 20, 2024, the entire contents of which are incorporated by reference herein.

### BACKGROUND

### 1. Field

An aspect of the invention relates to a device for providing control commands for at least one device of a motor vehicle to be controlled, wherein the at least one device to be controlled is in particular at least one actuator/at least one actuator group of the motor vehicle. Alternatively, sensors can also be controlled as devices to be controlled, for example in order to be switched on or activated. According to an aspect, the invention also relates to a motor vehicle with this device and a corresponding method for controlling at least one device of a motor vehicle. Lastly, an aspect of the invention also relates to a method for performing a driving dynamics test.

Testing new software is normally carried out in a vehicle prototype, wherein the new software is written to the existing control unit. If new hardware is to be tested, the control unit must be replaced in the workshop with the new hardware version (and, if necessary, with new software).

In general, testing new software and hardware in vehicle development in prototype vehicles is very costly. On the one hand, new or differently implemented functionalities of the control unit could cause unpredictable and unwanted behavior of the control unit, which could ultimately lead to a dangerous situation for the tester. The necessary hardware conversion requires a great deal of workshop effort.

### 2. Description of the Related Art

In general, DE 10 2020 216 481 A1 discloses a method for operating a control unit and a corresponding control unit, wherein several control units of a motor vehicle are equipped with several versions of control software. If an error is detected, it is possible to switch to an earlier software version.

### SUMMARY

One object of the invention is to facilitate the introduction of new control unit variants.

The object(s) of the invention is achieved by the subject matter of the independent claims. Advantageous further developments of the invention are described by the dependent claims, the following description, and the FIGURE(S). An object is therefore achieved by the device having the features according to claim 1, the motor vehicle having the features according to claim 8, the method having the features according to claim 11, and the method having the features according to claim 16.

The device, according to an aspect of the invention, is for providing control commands for at least one device to be controlled in a motor vehicle (in particular for at least one actuator of the motor vehicle). The device may comprise a first data input for first control commands of a predetermined type from a first control unit (device) according to an earlier control unit variant; a second data input for second control commands of the predetermined type from a second control unit (device) according to a newer control device variant; a data output to output the control commands for the at least one device to be controlled; a data processing device that is designed to determine, on the basis of an analysis of at least the second control commands (i.e., the data coming in via the second data input), whether the first or second control commands are forwarded to the at least one device to be controlled, and to effect a corresponding output via the data output.

According to an aspect, the invention has at least two aspects.

On the one hand, the newer control unit variant can be provided in a motor vehicle at the same time as the earlier control unit variant. The device according to the invention then makes it possible to decide in the motor vehicle which of the control unit variants is used in a particular situation. The ability to actively switch between two control unit variants makes it possible to compare these two versions directly with each other in the vehicle.

According to one preferred embodiment of the invention, a switching device is explicitly provided which is designed to receive the first and second control commands and serves to selectively forward the first or second control commands to the data output. In this case, the switching device is preferably part of the data processing device (provided/designed there as a software module, if necessary), so that in this case the data processing device also receives the first control command; it will receive the second one in order to perform the analysis. Alternatively, the switching device can be controlled by the data processing device. In this case, the switching device can also be implemented mechanically (as a relay) or as a small separate electronic component.

The aforementioned switching device can also be used to perform a quick switch, for example while the motor vehicle is in motion.

According to a further preferred embodiment of the device, it has a third data input via which input signals can be fed in which can also be fed to the first and second control devices and have thus been or could have been entered into the first and second control commands incoming via the first and second data inputs, and the data processing device is designed to also take into account these input signals supplied to the third data input during analysis.

In this case, the data processing device can perform a certain degree of plausibility checking and better assess, depending on the situation, whether the second control commands are helpful (braking when the motor vehicle swerves out of line by means of the brake control device).

Alternatively or additionally, it is also possible that the data processing device is designed to take the first control commands into account during analysis (in which case these should then be fed into the data processing device). Here, a direct comparison between the first and second control commands is possible, so that the data processing device can immediately detect the differences between the newer and earlier control device variants and check whether these are also appropriate (i.e., whether the newer control device variant does the same thing in some situations and/or is even better in other situations).

According to a further preferred embodiment of the device, it supports multiple functionalities for the at least one device to be controlled (including, if necessary, multiple subgroups of devices to be controlled, which may vary in composition). The data processing device is designed to assign first and second control commands to one of the functionalities in pairs. The analysis and the corresponding decision as to which of the first and second control commands are forwarded are made depending on the assigned functionality. In other words, a plurality of functionalities can be supported by the same device. For example, function blocks A and B may be taken over from the old control unit variant (because they have always run stably there, for example), and function block C is taken over from the new variant. This would simulate a new behavior of the control unit for the vehicle's setup without first having to request new control unit software with the desired properties from the supplier. This can be formulated as follows: the device is designed to forward first control commands relating to at least one first functionality by means of the output and to forward second control commands relating to at least one of the at least one first functionality by means of the output, wherein historical data is preferably stored in the device and/or the device recognizes, on the basis of an identifier in the first control commands, that the first control commands are already reliable with regard to the at least one first functionality.

According to a further preferred embodiment of the device, it comprises a memory for storing at least part of the received data and preferably for storing associated data relating to the determination of which of the first and second control commands are/were forwarded. In particular, the memory may be externally readable (in order to make the stored data available after a test drive of a vehicle prototype in the workshop). Alternatively or additionally, it may be provided that the device itself reads out the memory and actively sends the data, if necessary even wirelessly while the motor vehicle is in operation.

According to a further preferred embodiment of the device, the data processing device comprises a learning system which is designed to change (vary) the previous type of analysis on the basis of the control commands output via the data output and the data arriving via the data inputs.

The data processing device can thus learn when its decisions were correct and when they were not. In particular, it can learn when one control unit variant responded better and when the newer control unit variant responded better.

The motor vehicle according to the invention comprises the device according to the invention and at least one device to be controlled, the input of which is coupled to the data output of the device. It also comprises a first control unit according to an earlier control unit variant, the output of which is coupled to the first data input of the device, and it comprises a second control unit according to a newer control unit variant, the output of which is coupled to the second data input of the device.

The motor vehicle is the preferred application of the device. The advantages of the aforementioned device naturally also apply to the motor vehicle.

Preferably, the motor vehicle comprises the device with the third data input as mentioned above and additionally measuring devices (“sensors”), of which the outputs are coupled to inputs of the first and second control units and to the third data input of the device. In this way, the device is made able to reliably check how the two control unit variants respond to data inputs.

Since, according to the invention, it is no longer necessary to replace a control unit, but simply to have a second control unit in addition, together with the device according to the invention, this can be retrofitted very quickly in the prototype. It is therefore no longer necessary to install the newer control unit variant in the same location as an existing control unit. According to one embodiment, the device is arranged together with the second control unit (or one of the two) in a luggage compartment of the motor vehicle, or at another easily accessible location in the motor vehicle (rear seat, center console, or the like).

The method, according to an aspect of the invention, is for controlling at least one device of a motor vehicle, in particular an actuator of the motor vehicle.

The method may comprise supplying input data to a first control unit according to an earlier control unit variant, which issues first control commands, and to a second control unit according to a newer control unit variant, which issues second control commands.

The method may comprise receiving at least the second control commands and, using the second control commands, determining whether the first and second control commands are transmitted to the device, and outputting the control commands to the device accordingly.

The method according to the invention is the method as it can be implemented in the motor vehicle according to the invention. The advantages mentioned for the device and thus also for the motor vehicle apply accordingly to the method according to the invention.

According to a preferred embodiment of the method according to the invention, the determination is made simultaneously using the input data and/or the first control commands.

According to a further preferred embodiment of the method, the determination is repeated at regular intervals and/or in an event-driven manner. Here, the control unit in the newer control unit variant can be reliably monitored and dangerous situations can be effectively avoided.

The method works optimally (as do the device and the motor vehicle) if the first and second control units are designed to perform the same control unit task, wherein the first and second control units differ from each other in terms of hardware and/or software running on the hardware. Preferably, at least the hardware is different, in which case the installation of the newer control unit as an additional control unit together with the device is particularly useful.

According to a preferred embodiment of the method, an analysis is performed during the determination process which also detects whether the second control commands would be likely to cause a dangerous situation and/or an economically undesirable situation (high fuel consumption, wear and tear on parts), in which case a warning is issued. Alternatively or additionally, a safe state of the motor vehicle can be brought about (forced stopping or at least braking of the motor vehicle, in particular by semi-autonomous or fully autonomous control of the motor vehicle).

The warning can be given to the driver (in particular a test driver) as a warning signal (visual, acoustic, haptic), or corresponding information can be transmitted wirelessly to an external unit. Alternatively or additionally, it can be recorded in a memory of the device (or externally from it) that the dangerous situation or economically undesirable situation has been detected.

For the method, it is preferably provided—as indicated above for the device—that the device supports several functionalities, wherein the data processing device is designed to assign first and second control commands of one of the functionalities in pairs, and wherein, in the method, the determination of which of the first and second control commands are forwarded depends on the assigned functionality.

The method according to the invention for performing a driving dynamics test in a motor vehicle comprises providing the motor vehicle as described above together with the device, which also comprises the above-mentioned switching device. Now (preferably bypassing the determination by the data processing device), the switching device is used to forward the first control commands of the first control device for a first test action to the device to be controlled and to forward the second control commands of the second control device for a second test action to the device to be controlled. The first and second test actions involve driving the motor vehicle on the same or a comparable test track using a comparable driving style. In this way, the device according to the invention, in accordance with the preferred embodiment, can be used with a switching device for direct comparison of the two control unit variants.

In this context, it is preferably provided that, as part of the driving dynamics test, the data is also stored, using the memory of the device, as provided in the preferred embodiment, or an external memory outside the device.

For applications or application situations that may arise during the process and are not explicitly described here, it may be provided that, in accordance with the method, an error message and/or a request for user feedback is issued and/or a default setting and/or a predetermined initial state is set.

The invention also includes the control device for the motor vehicle. The control device may comprise a data processing device or a processor device (processor circuit) which is designed to carry out an embodiment of the method according to the invention. For this purpose, the processor device may comprise at least one microprocessor and/or at least one microcontroller and/or at least one FPGA (field programmable gate array) and/or at least one DSP (digital signal processor). In particular, a CPU (central processing unit), a GPU (graphical processing unit) or an NPU (neural processing unit) may be used as the microprocessor. Furthermore, the processor device may comprise program code which is configured to execute the embodiment of the method according to the invention when executed by the processor device. The program code may be stored in a data memory of the processor device. The processor device may be based, for example, on at least one circuit board and/or at least one SoC (system on chip).

The invention also includes further developments of the method according to the invention, which have features as already described in conjunction with the further developments of the device or the motor vehicle according to the invention. For this reason, the corresponding further developments of the method according to the invention are not described again here.

The motor vehicle according to the invention is preferably designed as a motor vehicle, in particular as a passenger car or truck, or as a passenger bus or motorcycle.

As a further solution, the invention also comprises a computer-readable storage medium comprising program code which, when executed by a computer or a computer network, causes the computer or computer network to execute an embodiment of the method according to the invention. The storage medium may be provided at least in part as a non-volatile data storage device (e.g., as a flash memory and/or as an SSD-solid state drive) and/or at least in part as a volatile data storage device (e.g., as a RAM-random access memory). The storage medium may be located in the computer or computer network. However, the storage medium may also be operated, for example, as a so-called app store server and/or cloud server on the Internet. The computer or computer network may provide a processor circuit with, for example, at least one microprocessor. The program code may be provided as binary code and/or as assembler code and/or as source code of a programming language (e.g., C) and/or as a program script (e.g., Python). Alternatively, the computer-readable storage medium may be implemented by a signal with computer-readable data, e.g., a time-varying voltage signal and/or a radio signal.

The invention also comprises combinations of the features of the described embodiments. The invention therefore also comprises implementations that each include a combination of the features of several of the described embodiments, provided that the embodiments have not been described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 shows an operating device disposed on a faceplate according to an aspect of the invention.

### DETAILED DESCRIPTION

Reference will now be made in detail to the preferred embodiments, examples of which are illustrated in the accompanying drawings, wherein like reference numerals refer to like elements throughout.

Exemplary embodiments of the invention are described below. In the drawings:

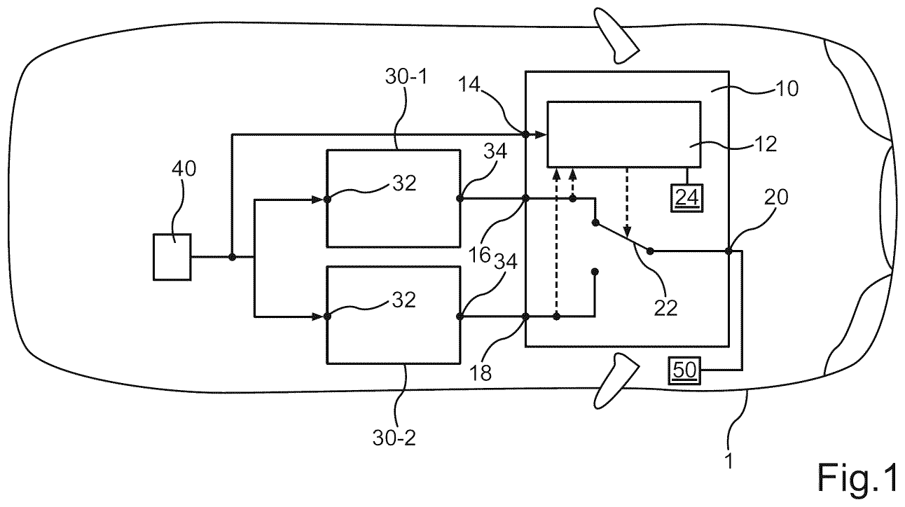

FIG. 1 shows a schematic representation of the basic components of a device of the type according to the invention in a motor vehicle of the type according to the invention for carrying out the method of the type according to an aspect of the invention.

The exemplary embodiments described below are preferred embodiments of the invention. In the exemplary embodiments, the components described in the embodiments represent individual features of the invention that are to be considered independently of one another and which also further develop the invention independently of one another. Therefore, the disclosure should also include combinations of the features of the embodiments other than those shown. Furthermore, the embodiments described can also be supplemented by other features of the invention already described.

In the FIGURE, identical reference signs denote elements with the same function.

In a motor vehicle designated as a whole by 1, control commands are ultimately to be sent to actuators 50 based on measured values from sensors, designated here by 40. For this purpose, there is a novel device 10 in the motor vehicle 1. The actual control commands are generated by a first control unit 30-1 and a second control unit 30-2, wherein these control units 30-1, 30-2 receive input signals from the sensors 40 via respective inputs 32 and output control commands via respective outputs 34. The control units 30-1 and 30-2 differ in terms of control unit variant. In the case of control unit 30-1, this may be a control unit that has already proven itself in practice but has been superseded by current developments in hardware and/or software. The control unit 30-2 is a newer control unit variant. The device 10, which can also be referred to here as a monitor control unit, has the property in the present case that it has data inputs, namely a data input 16 coupled to the output 34 of the first control unit 30-1, a data input 18 coupled to the output 34 of the second control unit 30-2, and a third data input 14 for those signals that are fed to the control units 30-1 and 30-2 as input signals, namely the signals from the sensors 40. The device 10 has a data processing unit 12 with a monitoring function. This determines whether the first control commands received via the data input 16 or the second control commands received via the data input 18 are ultimately fed to a data output 20 which is coupled to the actuators 50. The device 10 has a switching device 22 that can perform the corresponding switching. This is shown in the form of a relay switch, but the switching functionality can also be part of the data processing device 12, contrary to what is shown.

In general, the invention is applicable to the use of both analog and digital signals, in any combination with regard to the input signals and/or output signals of all devices. For example, the signals coming from the sensors 40 could be analog signals, which are then converted into digital signals in the control devices 30-1, 30-2, so that the device 10 receives analog signals via the input 14 and digital signals via the data inputs 16 and 18. Other variants are possible.

The lines shown here may also comprise combinations of more than one physical line.

The device checks the plausibility of the data received via the three data inputs and performs a monitoring function, which in turn can be configured, parameterized, or programmed using configuration software. This allows a control unit developer to decide which functions of the new control unit variant 30-2 should be assigned to the data output 20 without monitoring, which should be replaced by the function of the old control unit variant 30-1, which function should be compared with the function of the old control unit variant 30-1 (comparison of inputs 16, 18), which function should be validated by an independently programmed test, or whether validation should be performed by a hybrid of the last two procedures (comparison of the control commands received via data inputs 16, 18 and an additional independently programmed test).

Furthermore, reactions to error cases can be predefined in the data processing device 12. For example, in the event of incorrect behavior (according to a predetermined criterion) of the new control unit variant 30-2, the output can be overwritten by the events of the old control unit variant, a warning can be issued to the developer, and a safe state can be assumed, in particular, the motor vehicle can be brought to a halt or similar.

The received and generated data can be stored in a memory 24 of the device, and internal variables used for plausibility checks can also be logged for later analysis. Alternatively (not shown in the FIGURE), the input and output data can be transmitted live to a development computer outside the motor vehicle.

In the present case, the motor vehicle may be a prototype driven by a test driver. However, as technology advances, it may also be envisaged that a normal road vehicle will be equipped with the two control units 30-1 and 30-2 and the device 10 so that newer developments are available without creating a dangerous situation.

The device 10 can be implemented generically to ensure wide-ranging functionality. On the hardware side, the device 10 can be equipped as a monitor control unit with configurable inputs and outputs, which is also possible using both analog and digital signals. This allows the circuitry of conventional control units to be replicated. Configuration software should then be provided for configuring these circuits of device 10.

Overall, the examples show how monitoring hardware can be provided for the development and testing of control unit hardware and software.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A device providing control commands for at least one device to be controlled in a motor vehicle, comprising:
a first data input for first control commands of a predetermined type from a first control device according to an earlier control device variant;
a second data input for second control commands of the predetermined type from a second control device according to a newer control unit variant;
a data output to output respective control commands for the at least one device to be controlled; and
a data processing device which is designed to determine, based on an analysis of at least the second control commands, whether the first control commands or the second control commands are the respective control commands forwarded to the at least one device to be controlled, and to effect a corresponding output via the data output.

2. The device according to claim 1, wherein the at least one device is at least one actuator of the motor vehicle, and
the device comprises a switching device to receive the first control commands and the second control commands and for selectively forwarding the first control commands or the second control commands to the data output,
wherein the switching device is part of the data processing device or is controllable by the data processing device.

3. The device according to claim 1, wherein the device includes a third data input via which input signals are supplied which are also supplied to the first control device and the second control device and thus have been or could have been included in the first control commands and the second control commands received via the first data input and the second data input, and
wherein the data processing device is designed to also take into account the input signals supplied via the third data input during the analysis.

4. The device according to claim 2, wherein the device includes a third data input via which input signals are supplied which are also supplied to the first control device and the second control device and thus have been or could have been included in the first control commands and the second control commands received via the first data input and the second data input, and
wherein the data processing device is designed to also take into account the input signals supplied via the third data input during the analysis.

5. The device according to claim 1, wherein the data processing device is designed to also take into account the first control commands during the analysis.

6. The device according to claim 2, wherein the data processing device is designed to also take into account the first control commands during the analysis.

7. The device according to claim 3, wherein the data processing device is designed to also take into account the first control commands during the analysis.

8. The device according to claim 1, wherein multiple functionalities for the at least one device to be controlled are supported,
wherein the data processing device is designed to assign the first control commands and the second control commands of one of the multiple functionalities in pairs, and
the analysis and a corresponding decision as to which of the first control commands and the second control commands are forwarded are performed depending on the assigned functionality.

9. The device according to claim 1, further comprising:
a memory to store at least part of received data and associated data concerning the determination of which of the first control commands and the second control commands are forwarded.

10. The device according to claim 1, wherein the data processing device comprises a learning system that is designed to change a previous type of analysis based on the respective control commands output via the data output and data arriving via the first data input and the second data input.

11. A motor vehicle with a device providing control commands for at least one device to be controlled, an input of which is coupled to a data output of the device, and
a first control device according to an earlier control unit variant, an output of which is coupled to a first data input of the device, and a second control device according to a more recent control unit variant, the output of which is coupled to a second data input of the device.

12. The motor vehicle according to claim 11, with the device according to claim 3 and with measuring devices, of which outputs are coupled to inputs of the first control device and the second control device and to a third data input of the device.

13. The motor vehicle according to claim 11, comprising a luggage compartment in which the device and the second control device are arranged.

14. A method for controlling at least one device of a motor vehicle, in particular an actuator of the motor vehicle, comprising:
supplying input data to a first control device according to an earlier control unit variant, which issues first control commands, and to a second control device according to a newer control unit variant, which issues second control commands;
receiving at least the second control commands and, using the second control commands, determining whether the first control commands and the second control commands are transmitted to the at least one device, and outputting respective control commands to the at least one device accordingly, based on the determining.

15. The method according to claim 14, wherein the determining is made simultaneously using the input data and/or the first control commands.

16. The method according to claim 14, wherein the determining is performed repeatedly at regular intervals and/or in an event-driven manner.

17. The method according to claim 14, wherein the first control device and the second control device are designed to perform a control device task that is same, and wherein the first control device and the second control device differ from each other in terms of hardware and/or software running on the hardware.

18. The method according to claim 14, wherein an analysis is performed as part of the determining, which also detects whether the second control commands would be suitable for causing a dangerous situation and/or an economically undesirable situation, in which case a warning is issued and/or a safe state of the motor vehicle is brought about.

19. A method for performing a driving dynamics test in a motor vehicle, comprising:
providing the motor vehicle according to claim 8, which comprises the device according to claim 2 which includes the switching device, and
the method comprising:
forwarding, using the switching device, the first control commands of the first control device for a first test action to the device to be controlled and the second control commands of the second control device for a second test action to the device to be controlled, wherein the first test action and the second test action involve driving the motor vehicle on a test route that is same or a comparable test route with a comparable driving style.
